(19) United States
(12) Patent Application Publication
(10) Pub. No.: US 2005/0136835 A1
(43) Pub. Date: Jun. 23, 2005

(54) Radio relay device

(75) Inventor: Yutaka Suwa, Chikushino-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/012,340

(22) Filed: Dec. 16, 2004

(30) Foreign Application Priority Data
Dec. 17, 2003 (JP) 2003-419194

(51) Int. Cl. H04B 7/15

(52) U.S. Cl. 455/11.1; 455/41.2

(57) ABSTRACT

This invention provides a radio relay device with a small size and reduced cost which can prevent collision of communication data when the communication data are relayed in a plurality of radio networks.

The radio relay device relays the communication data between a parent device and a child device of a cordless telephone. The radio relay device includes a synchronization timing detector 16 for detecting a synchronization timing with the transmission of the parent device when relaying a packet transmitted from the parent device to the child device of a different radio network (piconet) and a timing correcting value buffer 20 for storing a correcting value computed from a difference between the synchronization timing and a clock in a bit counter 19. When the radio relay device relays the packet from the parent device to the child device, it communicates with the child device at the timing corrected on the basis of the correcting value extracted from the timing correcting value buffer 20.

### BACKGROUND OF THE INVENTION

1. Field of the Invention

This invention relates to a radio relay device capable of relaying a data communication, telephone call and communication data for printing in a master-slave type of radio network.

2. Description of the Related Art

In recent years, various standards of the radio network have been specified, and the radio network is connected to another radio network in the same standard having various uses.

For example, as regards the Bluetooth (trademark) in the radio network standard, not only a computer but also a computer peripheral device such as a printer and scanner and an electronic device such as a facsimile device, audio device and cordless telephone can be connected to one another in the Bluetooth standard. Thus, the respective electronic devices are adapted to transmit/receive information, sound, and images.

In the Bluetooth, within a piconet which is the radio network, an electronic device which performs a main control of communication is communicated with other electronic devices called slaves under the control of the master. Further, in the Bluetooth, a single master is included in a single piconet, and slaves can be connected a plurality of piconets so that the slaves are connected to the masters in the plurality of piconets.

Further, in the Bluetooth, communication is carried out through radio waves. Therefore, if a plurality of electronic devices simultaneously perform the communication, collision of the respective transmission data occurs so that the communication cannot be done. In order to obviate such an inconvenience, transmission timings as time division slots are allotted to the respective devices, thereby preventing collision of transmission/reception data.

The cordless telephone which is an example of the device which can be connected to the piconet constitutes the piconet including a master as a parent device and slaves as child devices. A person can move anywhere within a radio wave reaching range to have a talk with another person using the cordless telephone. In addition, by providing a repeater serving as a radio relay device within the range of the piconet, the communication range of the child device can be enlarged so that the demand for the repeater may be increased more and more.

Where the repeater is connected to the parent device serving as the master, it operates as the slave. On the other hand, where the repeater is connected to the child device serving as the slave, it operates as the master.

Referring to FIG. 10, a conventional radio relay device will be explained. FIG. 10 is a view showing the manner of connecting a repeater as an example of the conventional radio relay device to a radio network.

A repeater 100, which operates as the conventional radio relay device, performs the relay for two cordless telephones. A child device 102 of the cordless telephone within a first piconet 101 as the radio network is connected to a parent device 104 of the cordless telephone in a second piconet 103 through the repeater 100, thereby having conversation with a speaking partner connected to a public switched network 105.

A PDA (Personal Digital Assistance) 107 within a third piconet 106 is connected to through the repeater 100 an internet through the public switched network 105 via a parent device 109 within a fourth piconet 108.

First, the communication between the parent device 104 serving as a master and the repeater 100 serving as the slave is done as follows. The parent device 104 transmits a packet in synchronism with the clock of itself. The repeater 100 detects the timing of the clock of the parent device 104 on the basis of the packet received. In the transmission from the repeater 100 to the parent device 104, the repeater 100 transmits the packet in synchronism the clock of the parent device 104 on the basis of the detected timing of the clock of the parent device 104.

Next, the communication between the repeater 100 serving as the master and the child device 102 serving as the slave is done as follows. The repeater 100 transmits the packet in synchronism with its clock to the child device 102 serving as the slave. The child device 102 detects the timing of the clock of the repeater 100 on the basis of the packet received. In the transmission from the child device 102 to the repeater 100, the child device 102 transmits the packet in synchronism with the clock of the repeater 100 on the basis of the detected timing of the clock of the repeater 100.

The communication between the parent device 109 serving as the master and the repeater 100 serving as the slave is done as follows. The parent device 109 transmits the packet in synchronism with the clock of the parent device 109. The repeater 100 detects the timing of the clock of the parent device 109. In the transmission from the repeater 100 to the parent device 109, the repeater 100 transmits the packet in synchronism with the clock of the parent device 109 on the basis of the detected timing of the clock of the parent device 109. Likewise, between the repeater 100 and the PDA 107, communication is done using the packet in synchronism with the timing of the clock of the repeater 100.

In this way, in the case of the communication between the master and the slave, the slave can surely transmits the packet to the communication partner in such a manner that the slave transmits the packet in synchronism with the clock of the master.

However, the conventional radio relay device has the following disadvantage. The repeater 100 operating as the slave performs in synchronism with the parent device 104 serving as the master and also operates as the master for the child device 102. Namely, the child device 102 performs the communication in synchronism with the repeater 100 serving as the master.

Where the repeater 100 relays a synchronous packet between the parent device 104 and the child device 102 in a line switched system in which the packet is periodically transmitted/received, if the clock frequency of the parent device 104 does not perfectly agree with but slightly deviates from that of the repeater 100, the packets transmitted in synchronism with their respective clocks result in a step-by-step discrepancy in the transmission timings because of jitter due to the difference in the clock between the parent device 104 and the repeater 100.

Namely, if the transmission timing of the packet transmitted from the parent device 104 to the repeater 100 and that of the packet transmitted from the repeater 100 to the child device 102 are shifted to the same timing, collision of the packets occurs.

In order to solve such a problem, JP-A-10-233730 discloses a radio relay device for relaying communication data between a first radio communication device (public base station) and a second radio communication device (cellular phone).

In accordance with the radio relay device disclosed in Patent Reference 1, when the difference in the transmission/reception timing between the public base station and cellular phone becomes less than a predetermined time, a control data for changing the transmission/reception timing is transmitted to the public base station so that overlapping of the transmission/reception timing between the public base station and the cellular phone can be avoided.

Further, in the relay station for relaying communication for a moving body terminal disclosed in JP-A-2002-359590, when the communication for the moving body terminal is relayed to a switching station through a plurality of relay stations, a signal is transmitted with the entire slot timings of the relay stations being in synchronism with one another and delayed by one slot for each relay station, or otherwise with the frequency of the signal received by each relay station being changed. In this manner, the communication with good response can be realized by the signal with less delay.

Meanwhile, in the radio relay device disclosed in Patent Reference 1, it is necessary to detect that the difference in the transmission/reception timing between the public base station and the cellular phone becomes less than the predetermined time. This leads to a problem of enlarging the circuit scale.

In addition, overlapping of the transmission/reception timing between the public base station and the cellular phone is avoided by transmitting the control data for changing the transmission/reception timing to the public base station. This complicates the communicating procedure.

In the case of the synchronous packet in the line switched system, since the communication is performed at prescribed slot intervals, changing the transmission/reception timing leads to deterioration in a data quality. Further, the Bluetooth does not have the control data of changing the transmission/reception timing as a measure. Thus, the radio relay device described in Patent Reference 1 cannot be applied to the radio network such as the Bluetooth.

Further, in the relay station disclosed in Patent Reference 2, since the packet is delayed by one slot for each of the plurality of relay stations, the delay of the packet increases with an increase in the number of the steps of the relay stations. Where the frequency of the packet to be transmitted is changed, it cannot be changed optionally because in the radio network such as the Bluetooth, the frequency used for transmission/reception is prescribed according to a frequency hopping.

### SUMMARY OF THE INVENTION

In view of the above circumstance, this invention intends to provide a radio relay device with a small size and reduced cost which can prevent collision of communication data when the communication data are relayed in a plurality of radio networks.

This invention provides a radio relay device for receiving a synchronous packet in a line switched system transmitted from an electronic device serving as a master connected to a radio network and relaying, as the master, the synchronous packet thus received to another electronic device serving as a slave connected to another radio network different from the radio network, including: a synchronization timing detecting unit for detecting a synchronization timing synchronous with the electronic device serving as the master from the packet transmitted from the electronic device serving as the master; a timing correcting unit for computing a correcting value for correcting a timing of transmitting the packet to another electronic device on the basis of the timing detected by the synchronization timing detecting unit, wherein when a radio relay unit relays the synchronous packet transmitted from the electronic device serving as the master is relayed, it transmits the synchronous packet to the other electronic device at the timing corrected on the basis of the correcting value.

In this configuration, in communication with the other electronic device serving as the slave, the relay apparatus can communicate with the other electronic device at the corrected timing so that the packet transmission/reception for the electronic device serving as the master and that for the other electronic device serving as the slave are executed at the timing synchronous with the clock of the electronic device serving as the master. Thus, it is possible to prevent the transmission timings of the packet from gradually shifting to the same timing, thereby preventing collision of packets. Further, in a simple configuration, synchronization of the packets can be taken so that the communicating procedure or circuit for changing the transmission timing using e.g. a control data is not required.

### BRIEF DESCRIPTION OF THE DRAWINGS

FIG. 1 is a view showing the configuration in which a repeater which is an example of the radio relay device according to an embodiment of this invention is connected to radio networks.

FIG. 2 is a view of the construction of the repeater which is an example of the radio relay device according to an embodiment of this invention.

FIG. 3 is a timing chart showing the relationship between the format of a packet used in the Bluetooth and clocks.

FIG. 4 is a flowchart for explaining the method of computing a correcting value which represents a deviation from the timing synchronous with the master in the packet received by a repeater from a master.

FIG. 5 is a view showing an example of the contents of a timing correcting buffer.

FIG. 6 is a flowchart for explaining the transmission timing synchronous with the master when a synchronous packet is transmitted from the repeater.

FIG. 7 is a view showing in detail the correction of the packet transmission timing in the repeater.

FIG. 8 is a view showing an example of the communication in which a parent device and child device and the parent device and PDA are relayed by a repeater, respectively.

FIG. 9 is a view showing packet transmission timings in detail in the case where two relays are concurrently by the repeater.

FIG. 10 is a view showing the configuration in which a repeater which is an example of a conventional radio relay device is connected to radio networks.

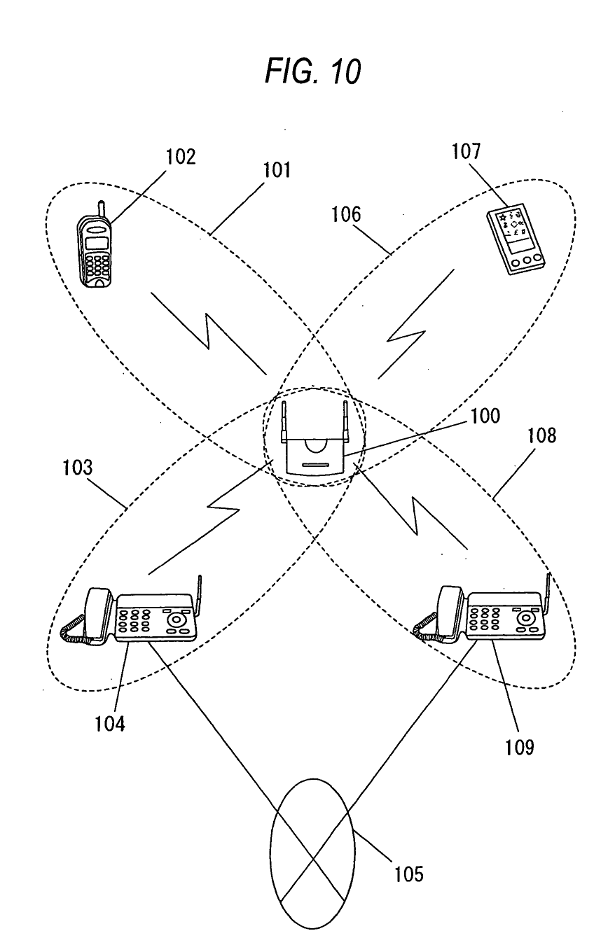

### DESCRIPTION OF THE PREFERRED EMBODIMENTS

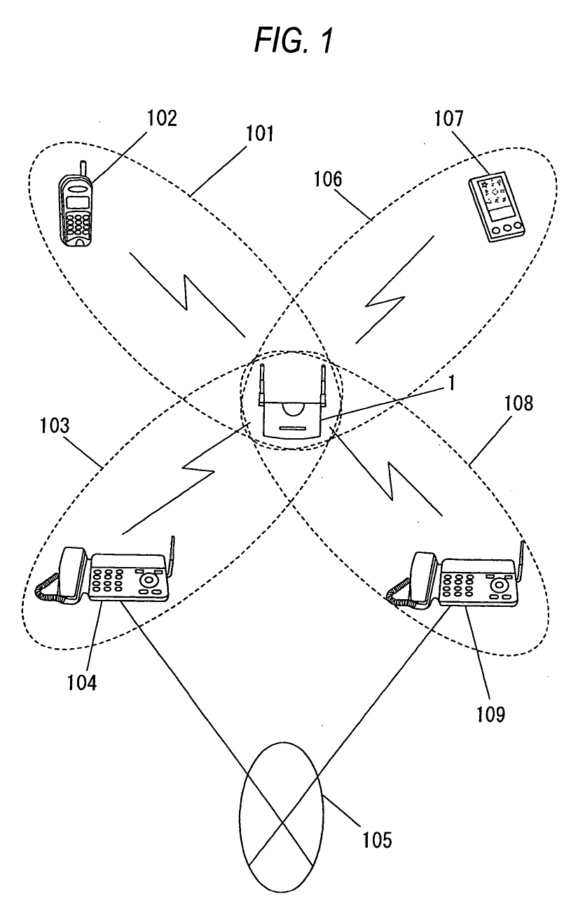

Now referring to the drawings, an explanation will be given of an embodiment of this invention. FIG. 1 is a view showing the configuration in which a repeater which is an example of the radio relay device according to an embodiment of this invention is connected to radio networks.

In the example shown in FIG. 1, a repeater 1 which is a radio relay device belongs to four radio networks, i.e. a first piconet 101, a second piconet 103, a third piconet 106 and a fourth piconet 108. In the first piconet 101 and third piconet 106, a repeater 1 serves as a master. In the second piconet 103, the repeater 1 serves as a slave and is connected to a parent device 104 serving as a master. In the fourth piconet 108, the repeater 1 serves as the slave and is connected to a parent device 109 serving as the master.

A child device 102 of the cordless telephone within the first piconet 101 as the radio network is connected to the parent device 104 of the cordless telephone through the repeater 100, thereby having conversation with a speaking partner connected to a public switched network 105.

A PDA (Personal Digital Assistance) 107 within the third piconet 106 is connected through the repeater 100 to an internet through the public switched network 105 via a parent device 109 within the fourth piconet 108.

Where the repeater 1 relays a packet from the parent 104 and child device 102 between which an audio data is transmitted/received, in the second piconet, the repeater 1 serving as the slave receives the packet transmitted from the parent device 104 serving as the master, and in the first piconet, the repeater 1 serving as the master transmits the received packet to the child device 102 serving as the slave.

Likewise, where the repeater 1 relays the communication data from an internet to the parent device 109 and PDA 107, in the fourth piconet 108, the repeater 1 serving as the slave receives the packet transmitted from the parent device 109 serving as the master and in the third piconet 106, the repeater 1 serving as the master transmits the received packet to the PDA 107 serving as the slave.

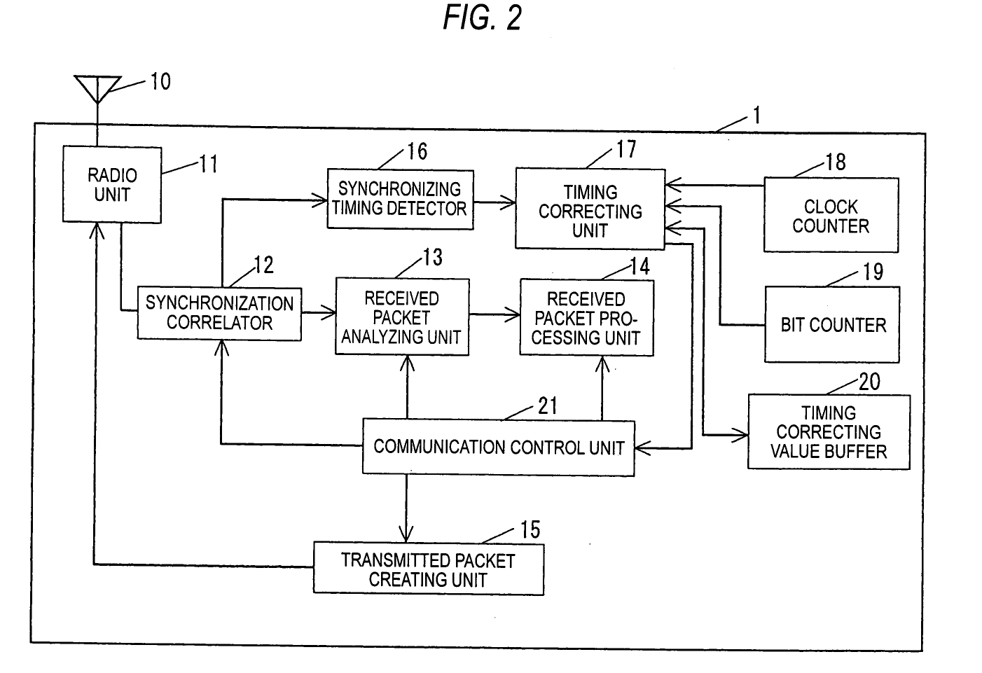

Next, referring to FIG. 2, an explanation will be given of the configuration of a repeater which is an example of the radio relay device according to an embodiment of this invention. FIG. 2 is a block diagram of the repeater which is an example of the radio relay device according to the embodiment of this invention.

A repeater 1 includes an antenna 10, a radio unit 11 for performing transmission/reception of a signal in a time divisional communicating system, a synchronization correlator 12, a received packet analyzing unit 13, a received packet processing unit 14, a transmitted packet creating unit 15, a synchronizaton timing detector 16, a timing correcting unit 17, a clock counter 18, a bit counter 19, a timing correcting value buffer 20 and a communication control unit 21.

The antenna 10 receives a packet transmitted via a radio wave from another electronic device connected to a radio network or transmitted directly or a repeater device which is a relay device.

The radio unit 11 carries out the transmission/reception of a signal in a time divisional system using a frequency band from 2.402 GHz to 2.480 MHz called an ISM (Industry Science Medical). The radio unit 11 also modulates transmitted data in a binary frequency shift keying system and demodulates the data on the basis of the signal received in the same system.

The synchronization correlator 12 has a buffer for storing the received packets, which stores one bit for each packet and monitors whether or not the received packet is a packet directed to the repeater 1 on the basis of the access code which is a leading segment of the packet. If the synchronization correlator 12 determines that the received packet is the packet directed to the repeater 1, it sends the packet to the received packet analyzing unit 13.

The received packet analyzing unit 13 analyzes an SCO packet in a line switched system mainly used for synchronous communication of audio data and an ACL packet in a packet switched system used for asynchronous communication such as data transmission/reception.

The received packet processing unit 14 processes the SCO packet received in the line switched system and the ACL packet received in the packet switched system. The transmitted packet creating unit 15 receives transmitted data from the communication control unit 21 and creates the packet in conformity with the format of the SCO packet and the ACL packet on the basis of the received data.

The synchronization timing detector 16 detects, on the basis of the packet received from the synchronization correlator 12, the timing (T) when reception of the preamble and synchronous word included in the access code which is the leading segment of the packet has been completed, thereby creating an interruption for the timing correcting unit 21.

The clock counter 18 creates a fundamental clock used within the piconet. The clock CL created by the clock counter 18 is called a Bluetooth clock having a period of 312. 5 μs. A two-period time (625 μs) of the clock CL constitutes a single slot. For example, where the master performs the transmission during an even slot, the slave perform the transmission during an odd slot. Namely, in a minimum slot communication (transmission during the single slot and the reception during the single slot), a transmission timing comes every 1.25 ms and a reception timing comes every 1.25 ms.

The bit counter 19 counts 1 μs pulses and produces a counted value which returns from a maximum “1249” to “0”. The clock counted by this bit counter 19 is a fundamental clock for correcting a drift called a “slot offset” on the basis of the data transmitted from the electronic device which is a communication partner.

Generally, the master performs the communication at its own clock and timing. Therefore, in the minimum slot communication, the time from 0 to 624 of the value of the bit counter is a transmission period whereas the time from 625 to 1249 is a reception period. By correcting the value in its own bit counter to remove the discrepancy between the master and the slave, the slave adapts its transmission period to the time from 625 to 1249 of the value of the bit counter in the master.

Where the packet is received from the master, when the timing correcting unit 17 receives, from the synchronization timing detector 16, an interruption indicative of the detection of the synchronization timing, it reads the correcting value, i.e. the slot offset from the bit counter 19, and stores this correcting value in the timing corrected value buffer 20.

Where the packet is transmitted in synchronism with the master, the timing correcting unit 17 reads the correcting value from the timing correcting value buffer 20, and informs the communication control unit 21 of the timing obtained by correcting the value in the bit counter 19 on the basis of the above correcting value.

The timing correcting value buffer 20 is a storage unit for storing the correcting value i.e. the slot offset and for storing the electronic device with an identified communication partner corresponding to the slot offset from a Bluetooth address (BD_ADDR).

The communication control unit 21 executes the whole control for the synchronization correlator 12, received packet analyzing unit 13, received packet processing unit 14 and transmitted packet creating unit 15.

Further, in the relay of data between the parent device 104 and child device 102 which communicate the SCO packet, for the communication with the parent device 104 serving as the master, the communication control unit 21 operates as the slave by returning the packet at the timing in synchronism with the packet from the parent device 104. Also, for the communication with the parent device 104 also, the communication control unit 21 performs the control of communicating the SCO packet at the timing in synchronism with the parent device 104. In short, the timing correcting unit detects the drift in the clock of the SCO packet received from the parent device 104, and in the transmission to the parent device 104 and the child device 102, the communication control unit 21 transmits the SCO packet at the timing obtained by correcting the clock CL created by the clock counter 18 on the basis of the correcting value acquired from the drift.

Further, in the relay of data between the parent device 109 and PDA 107 which communicate the ACL packet, for the communication with the parent device 109 serving as the master, the communication control unit 21 operates as the slave by returning the packet at the timing in synchronism with the packet from the parent device 109. On the other hand, for the communication with the PDA 107, the communication control unit 21 operates as the master to performs the control of communicating the ACL packet at the slot timing created on the basis of the clock in the repeater 1. In short, for the transmission to the parent device 109, the timing correcting unit 17 detects the drift in the clock of the ACL packet received from the parent device 109, and the communication control unit 21 transmits the ACL packet at the timing obtained by correcting the clock CL created by the clock counter 18 on the basis of the correcting value acquired from the drift. On the other hand, for the transmission to the PDA 107, without correcting the clock, the communication control unit 20 performs the transmission/reception of the ACL packet at the timing in synchronism with the clock peculiar to the repeater 1 created by the clock counter 18.

These units inclusive of the received packet analyzing unit 13, received packet processing unit 14, transmitted packet creating unit 15, clock counter 18, bit counter 19, communication control unit 21, synchronization timing detector 16 and timing correcting unit 17 can be constructed by a gate array, MPU (Micro Processing Unit), ROM (Read Only Memory) storing a control program, or RAM (Random Access Memory) used for read/write for a program.

The timing correcting buffer 20 may be constructed by a SRAM (Static Random Access Memory) or DRAM (Dynamic Random Access Memory) which is rewritable.

Now referring to FIGS. 1 to 5, an explanation will be given of the operation of the radio relay device according to an embodiment of this invention.

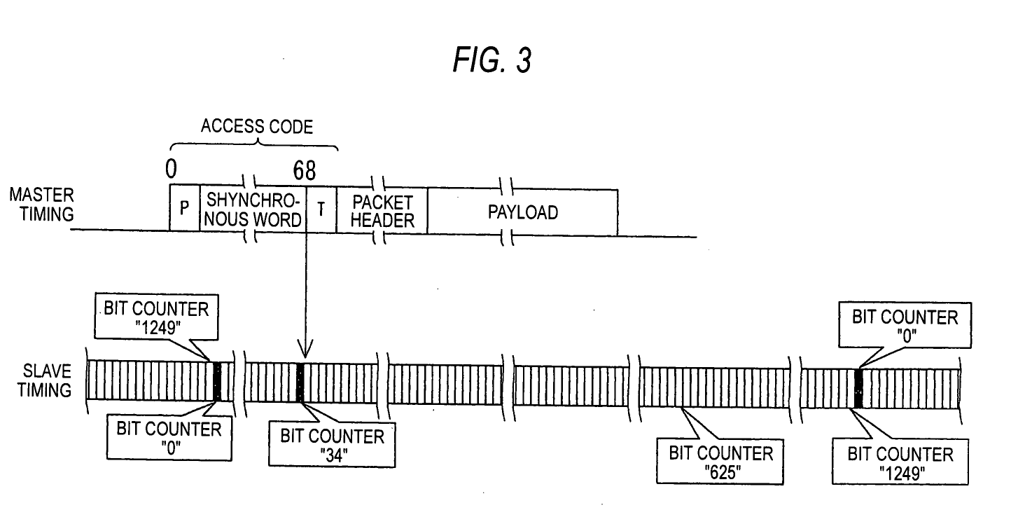

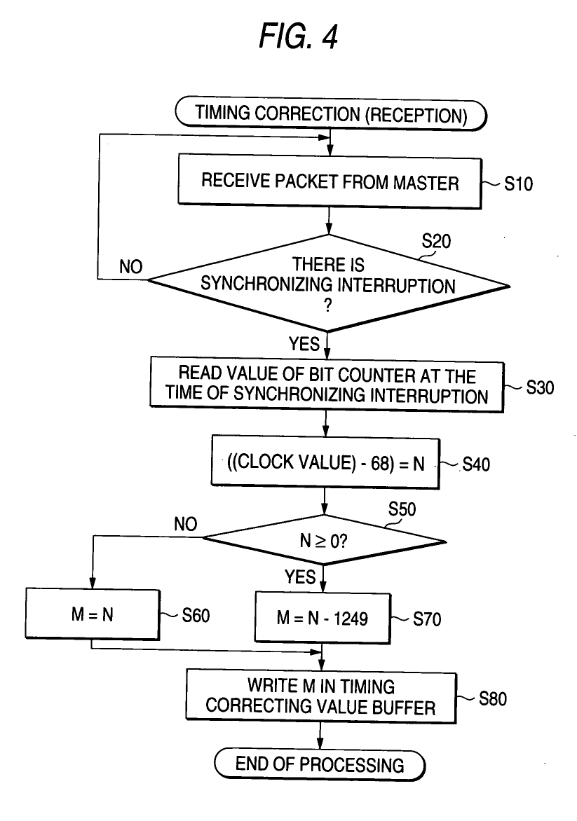

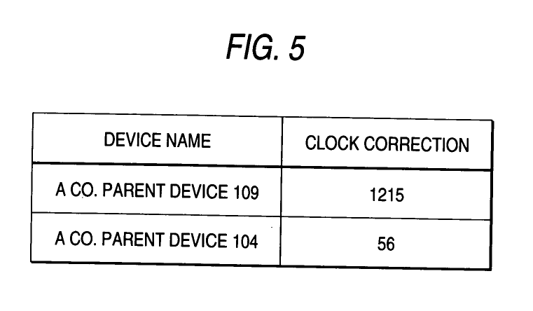

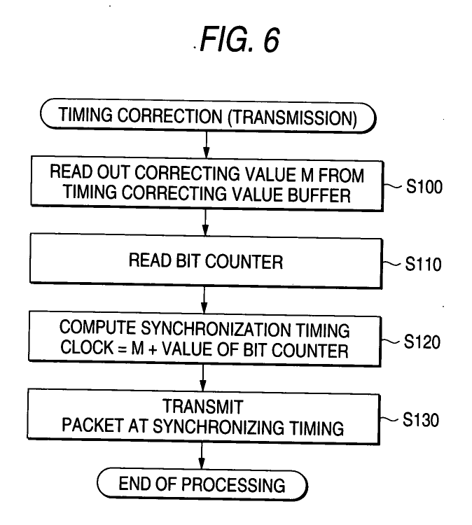

FIG. 3 is a view showing the relationship between the format of a packet used in the Bluetooth and clocks. FIG. 4 is a flowchart for explaining the method of computing a correcting value which a drift from the timing synchronous with the master in the packet from the master received by the repeater. FIG. 5 is a view showing an example of the contents of the timing correcting value buffer 20. FIG. 6 is a flowchart for explaining the timing synchronous with the master when the packet is transmitted from the repeater.

The packet used in the Bluetooth includes an SCO packet which is a synchronous packet in the line switched system and an ACL packet in the packet switched system. These packets each is composed of an access code, a packet header and a payload. The master timing is extracted from the access code at a leading segment of each of these packets transmitted from the parent device 104 or 109 serving as the master. The access code is composed of a preamble of 4 bits of binary 1 and 0 repeatedly arranged, a synchronous word which is an identifier of 64 bits called a Bluetooth address and a trailer of 4 bits of binary 1 and 0 repeatedly arranged like the preamble.

The packet header contains a parameter necessary to manage the communication. The payload contains audio data of a speech, data to be communicated, and a control command, etc.

The repeater 1 serving as the slave monitors whether or not the packet received by the synchronization correlator 12 is a packet of the radio network to which the repeater 1 is connected, and whether the AM_ADDR of the packet received by the received packet processing unit 14 represents the packet directed to the repeater 1. If it is determined that the received packet is a packet directed to the repeater 1, the synchronization timing detecting unit 16 creates an interruption at the timing having detected the final bit of the preamble and synchronous word, thereby reading the value at this time from the bit counter 19 and recognizing a clock drift from the master on the basis of the value thus read.

In the example, at the timing of the final bit (68) of the synchronous word, the value of the bit counter is “34” so that there is a drift of 34 μs. Thus, the timing of the final bit of the synchronous word of the packet transmitted from the master represents the clock drift in the slave.

Next, an explanation will be given of the method for detecting a correcting value of the clock drift from the master when the repeater 1 serving as the slave receives the packet.

In FIG. 4, in S10, when the radio unit 11 receives the packet transmitted from the parent device 104 or 109 serving as the master, the synchronization correlator 12 accumulates the data within the packet one bit by one bit to monitor whether or not the packet received is directed to the repeater 1 on the basis of the information of the preamble and the synchronous word of 64 bits.

In S20, the synchronization timing detecting unit 16 returns to S10 until the timing of the final bit of the synchronous word of the packet accumulated is detected. If the synchronization timing detecting unit 16 detects the final bit of the synchronous word which represents the synchronization timing with the master, it creates an interruption indicative of the clock synchronization for the timing correcting unit 17.

In S30, in response to the creation of the interruption from the synchronization timing detecting unit 16, the timing correcting unit 17 reads the value of the clock form the bit counter 19.

In S40, the timing correcting unit 17 performs the processing of computing the value N when “68” is subtracted from the value in the bit counter 19. For example, in the case of FIG. 3, since the drift is “34”, the value of N is “−34”.

In S50, the timing correcting unit 17 determines whether or not the value of N is not smaller than 0. If N is smaller than “0”, in S60, N is adopted as the correcting value M as it is. Therefore, since N is “−34”, M is “−34”.

If N is not smaller than “0”, in S70, the timing correcting unit 17 computes the value when “1249” is subtracted from N, and adopts the value thus obtained as the correcting value M.

In S80, the timing correcting unit 17 stores, in the timing correcting value buffer 20, the correcting value M so as to correspond to the information identifying the master. Namely, where the repeater 1 communicates with a plurality of masters, the timing correcting unit 17 individually stores the correcting value M so as to correspond to the information for identifying the respective masters. FIG. 5 shows an example of the contents of the timing correcting value buffer 20 in which the correcting value M is stored so as to correspond to the information of identifying the masters. In the example shown in FIG. 5, since “1215” is stored as the correcting value M used for communication with the parent device 109 serving as the master, M:1215 is adopted as the timing correction for the slot during which the repeater executes the transmission/reception for the parent device 109. M: 56 is adopted as the timing correction for the slot during which the repeater 1 executes the transmission/reception for the parent device 104.

Incidentally, the device name for identifying the master corresponds to the BD_ADDR and a device class of the FHS packet transmitted from the master at the time of calling. The device class is a region for defining the kind of a 24 bit device stored in the FHS packet, in which the kind of each of a computer, telephone and audio device and its detailed information are stored in their codes. For this reason, the device class as well as BD_ADDR can be employed as the device name for identifying the master.

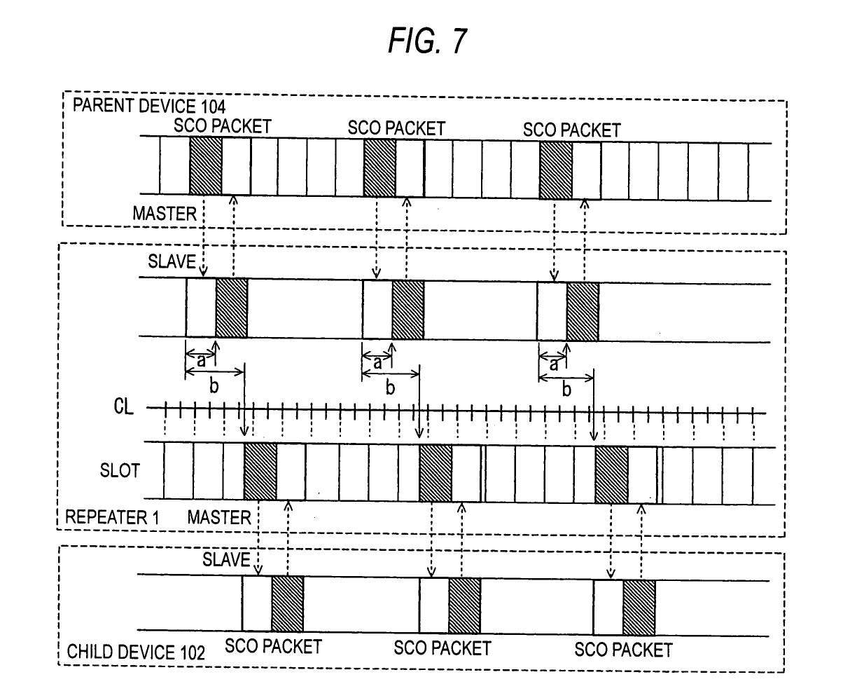

Next, referring to FIGS. 6 and 7, an explanation will be given of the timing correction in the cases where the repeater 1 serving as the slave returns the packet to the parent device and where the repeater 1 serving as the master transmits the SCO packet to the child device.

In S100, the timing correcting-unit 17 reads out the correcting value M from the timing correcting value buffer 20. In the case of FIG. 3, M is “−34”. In S110, the timing correcting unit 17 reads out the value of the bit counter 19.

In S120, the timing correcting unit 17 computes a sum of the read value of the bit counter 19 and “−34”. The timing correcting unit 17 waits for the timing when the sum reaches “0”, and when “0” is detected, informs the communication control unit 21 of this fact.

In S130, in response the information from the timing correcting unit 17, the communication control unit 21 instructs the transmitted packet creating unit 15 to start the transmission of the packet for the parent device and the transmission of the packet for the child device. Thus, the SCO packet or ACL packet is transmitted through the radio unit 11.

FIG. 7 shows the corrected timings of starting the transmission of the SCO packet for the parent device and child device in the repeater 1. The repeater 1 performs the communication in the transmission/reception slot which is switched every two periods of the fundamental clock CL (Bluetooth clock) created by the clock counter 18 and employed in the piconet as described above. In this case, as seen from FIG. 7, the time difference a from when the repeater (slave) receives the SCO packet transmitted from the parent (master) to when the repeater returns the SCO packet to the parent device is the time difference corrected by the timing correcting unit 17. The time difference b from when the repeater receives the SCO packet transmitted from the parent device to when the repeater 1 transmits the SCO packet to the child device is also the time difference corrected by the timing correcting unit 17. In this way, the packet transmission timing is corrected by the timing correcting unit 17 so that the SCO packet is transmitted at the time position deviated from the normal transmission/reception slot of the repeater.

Also in the case where the packet transmitted from the parent device (master) is the ACL packet, the time difference unit the repeater returns the ACL packet to the parent device is corrected by the timing correcting unit 17. As a result, when the packet transmitted by the repeater 1 is either the SCO packet or the ACL packet, the repeater 1 can transmit the packet in synchronism with the communication clock of the parent device.

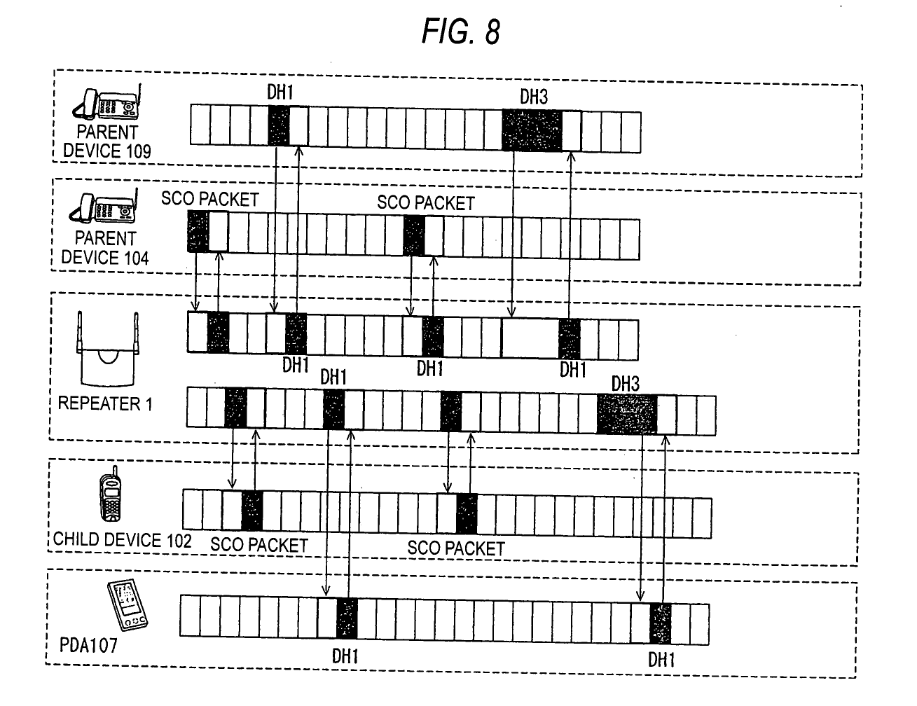

Next, referring to FIG. 8, an explanation will be given of an example of the communication relayed by the repeater 1 between the parent device 104 and the child device 102 and between the parent device 109 and the PDA 107. In the example shown in FIG. 8, the repeater 1 relays the communication of the SCO packet of the audio data in the line switched system between the parent device 104 and the child device 102, and also relays the ACL packet in the packet switched system between the other parent device 109 and the PDA 107.

In this case, the repeater 1 serving as the slave transmits/transmits the SCO packet in synchronism with the communication clock of the parent device 104 serving as the master. As regards the timing of the slot for the transmission/reception between the repeater 1 and the parent device 104, the transmission/reception for the repeater 1 accords with the transmission timing of the parent device 104. Further, as regards the timing of the slot for the transmission/reception between the repeater 1 and the child device 102, the child device 102 serving as the slave accords with the transmission timing of the repeater 102.

In this case, as described above, the repeater 1 transmits the SCO packet to the child device 102 at the slot timing obtained by correcting the clock CL created by the clock counter 18, i.e. the system clock of the repeater 1 using the correcting value. In this way, since the transmission timing of the repeater 1 for the child device 102 is corrected to be always synchronous with the transmission timing of the parent device 104, it is possible to prevent the transmission timings of the packet from gradually shifting to the same timing.

Further, in order that the PDA 107 can access the home page on an internet through the parent device 109, the repeater 1 relays the communication of the ACL packet in the packet switched system between the PDA 107 and the parent device 109. In this case, the repeater 1 serving as the slave transmits/receives the ACL packet in synchronism with the communication clock of the parent device 109 serving as the master. Further, the repeater 1 serving as the master communicates with the child device 102 in synchronism with the timing of the bit counter 19, i.e. the system clock of the repeater 1. In the communication of the ACL packet between the parent device 109 and PDA 107, the PDA 107 reads the home page on its screen in a DH1 packet employed for request of transmission of a page or communication of a text, and in a DH3 packet employed for communication of a large quantity of data such as an image.

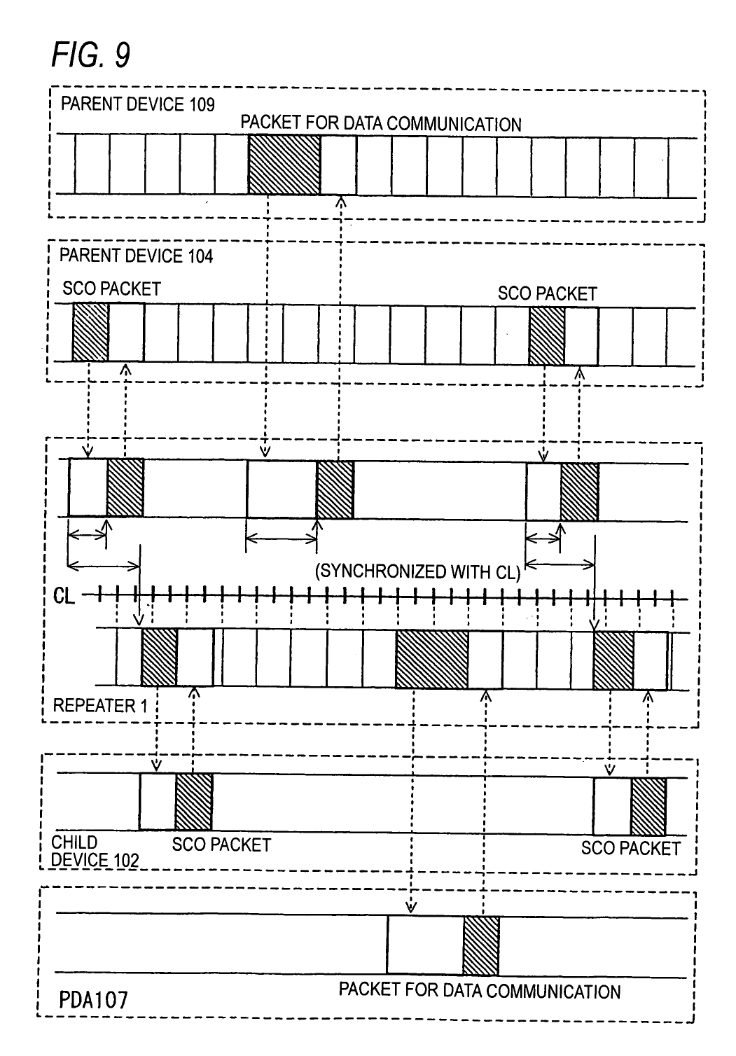

Thus, the repeater 1 can relay the parent device 104 with the child device 102 while transmitting/receiving the SCO packet in the line switched system (synchronous communication) for audio communication, and can also relay the parent device 109 with the PDA 107 while transmitting/receiving the ACL packet in the packet switched system (asynchronous communication) for data communication. FIG. 9 shows in detail the SCO packet transmission starting timings for the parent device 104 and the child device 102 and the ACL packet transmission starting timings for the parent device 109 and the PDA 107 in the case where the repeater 1 concurrently performs two relays.

Where the repeater 1 performs the relay for a plurality of parent devices, since the clock of the repeater 1 deviates from that of the parent device 104 or 109, initially, the transmission timings can be designed to not overlap. However, with passage of time, the transmission timings of the respective devices will overlap so that collision of the packets may occur. However, in this invention, where the packet (SCO or ACL) transmitted from the parent devices is returned to the respective parent devices, since the packet is transmitted in synchronism with the communication clock of each of the parent devices, there is very little possibility that the transmission timings of the repeater 1 and each parent device overlap owing to the drift of the clocks. Further, in the communication of the ACL packet (asynchronous) between the parent device 109 and the repeater 1, the transmission timing of the repeater is made synchronous with the communication clock of the parent device 109. On the other hand, in the communication between the repeater 1 and the PDA 107, as described in FIG. 9, since the repeater 1 serving as the master transmits the packet in synchronism with the clock CL of the repeater itself, the repeater 1 can select the transmission slot for the PDA 107 at a suitable timing position not overlapping (not too dose) with the transmission/reception of the other parent devices.

Thus, even where the repeater 1 performs a plurality of relays in which the SCO packets in the line switched system (synchronous communication) and the ACL packets in the packet switched system (asynchronous communication) are mixed, useless consumption of time can be minimized while avoiding collision of the packets, thereby improving the communication efficiency.

1. A radio relay device capable of relaying a packet received from a first electronic device to a second electronic device, comprising
a timing correcting unit, computing a correcting value for correcting a timing of transmitting a synchronous packet to the second electronic device on the basis of a synchronization timing detected from the synchronous packet transmitted from the first electronic device, wherein
when an asynchronous packet is relayed, the asynchronous packet is transmitted to the second electronic device at a timing created within the radio relay device, and
when the synchronous packet is relayed, the synchronous packet is transmitted to the second electronic device at the timing corrected on the basis of the correcting value.

2. A radio relay device capable of relaying a packet received from a first electronic device to a second electronic device, comprising:
a radio unit, transmitting/receiving a signal in a time divisional system;
a synchronization timing detecting unit, detecting a synchronization timing with a first electronic device from the packet transmitted from the first electronic device;
a timing correcting unit, computing a correcting value for correcting a timing of transmitting the packet to the second electronic device on the basis of the timing detected by the synchronous timing detecting unit, wherein
when a radio unit relays an asynchronous packet transmitted from the first electronic device to the second electronic device is relayed, it transmits the asynchronous packet to the second electronic device at a timing created within the radio relay device, and
when the radio unit relays the synchronous packet transmitted from the first electronic device to the second electronic device, it transmits the synchronous packet to the second electronic device at the timing corrected on the basis of the correcting value.

3. The radio relay device according to claim 2, further comprising:
a storage unit, storing a correcting value for correcting a timing of transmitting the packet to the second electronic device, wherein
if the first electronic device which is a transmission source is one of a plurality of electronic devices, the storage unit stores the correcting value corresponding to each of the plurality of electronic devices, and in communication with each of the electronic devices, the radio unit transmits the synchronous packet at the timing corrected on the basis of the correcting value corresponding to each of the plurality of electronic devices.

4. A radio relay device capable of receiving a packet from a first electronic device and relaying the packet thus received to a second electronic device, comprising:
a radio unit, transmitting/receiving a signal in a time-divisional system;
a synchronization timing detecting unit, detecting a synchronization timing with a first electronic device from the packet transmitted from the first electronic device;
a timing correcting unit, computing a correcting value for correcting a timing of transmitting the packet to the second electronic device on the basis of the timing detected by the synchronous timing detecting unit;
a storage unit, storing the correcting value,
wherein
when a synchronous packet is relayed, the radio unit transmits the synchronous packet to the second electronic device at the timing corrected on the basis of the correcting value extracted from the storage unit, and
when an asynchronous packet is relayed, the radio unit transmits the asynchronous packet to the second electronic device at the timing not according with the correcting value.

5. A radio relay device capable of receiving a synchronous packet in a line switched system from an electronic device serving as a master and relaying the synchronous packet thus received to another electronic device serving as a slave as the master itself, comprising
a radio unit, transmitting/receiving a signal in a time divisional system;
a clock generating unit, generating a clock for communication of the radio unit;
a synchronization timing detecting unit, detecting a timing synchronous with the electronic device serving as the master from the packet transmitted from the electronic device serving as the master;
a timing correcting unit, computing, as a correcting value, a difference between the timing detected by the synchronization timing detecting unit and a fundamental timing of the clock; and
a storage unit for storing the correcting value,
wherein
when a synchronous packet is relayed from the electronic device serving as the master to another electronic device serving as the slave, the radio unit transmits the synchronous packet to the electronic device serving as the slave at the timing of the clock corrected on the basis of the correcting value extracted from the storage unit.

6. A radio relay device according to claim 5, wherein
if the electronic device serving as the master is one of a plurality of electronic devices, the storage unit stores the correcting value corresponding to each of the plurality of electronic devices, and in communication with each of the electronic devices, the radio unit performs the communication at the clock corrected on the basis of the correcting value corresponding to each of the plurality of electronic devices.

7. The radio relay device according to claim 5, wherein where
the packet transmitted from the electronic device is an asynchronous packet in a packet switched system, the radio unit, when relaying the asynchronous packet in the packet switched system to the other electronic device, performs the communication in synchronism with the clock.

8. A radio relay device capable of receiving a synchronous packet in a line switched system or an asynchronous packet in a packet switched system from an electronic device serving as a master connected to a radio network and relaying the packet thus received to a third electronic device serving as a slave connected to another network different from the radio network, comprising
a radio unit;
a clock generating unit for generating a clock for communication of the radio unit;
a synchronization timing detecting unit for detecting a timing synchronous with the electronic device serving as the master from the packet transmitted from the electronic device serving as the master;
a timing correcting unit for computing, as a correcting value, a difference between the synchronous timing and a fundamental timing of the clock;
a storage unit for storing the correcting value; and
a communication control unit, wherein
where the packet transmitted from each of a plurality of electronic devices serving as the masters is relayed to another electronic device serving as the slave, the communication control unit controls the radio unit so that the packet transmitted from a first electronic device serving as the master is transmitted to the third electronic device at the timing of the clock corrected on the basis of the correcting value extracted from the storage unit, and if the packet transmitted from a second electronic device is an asynchronous packet in a packet switched system, the communication control unit controls the radio unit so that when the asynchronous packet in the packet switched system is relayed to the electronic device serving as the slave, the asynchronous packet is transmitted to the third electronic device in synchronism with the clock.

9. The radio relay device according to claim 8, further comprising a clock counter for generating a fundamental clock used in the radio network around the relay radio relay device, wherein
the timing correcting unit detects a drift between a timing of an SCO packet received from the first electronic device and a clock CL created by the clock counter and stores a correcting value acquired from the drift in the storage unit;
the timing correcting unit detects a drift between a timing of an ACL packet received from the second electronic device and the clock CL created by the clock counter and stores a correcting value acquired from the drift in the storage unit; and
the communication control unit, in the relay of the SCO packet communicated between the first electronic device and the third electronic device, returns the SCO packet to the first electronic device and also transmits the SCO packet to the third electronic device at the timing corrected using the correcting value stored in the storage unit; and in the relay of the ACL packet communicated between the second electronic device and the fourth electronic device, returns the ACL packet to the second electronic device at the timing corrected using the correcting value, but transmits the ACL packet to the fourth electronic device at the timing according with the clock peculiar to the radio relay device without correcting the clock.
